(19) United States
(12) Patent Application Publication
(10) Pub. No.: US 2013/0264276 A1
(43) Pub. Date: Oct. 10, 2013

(54) Filter Media Treated with Cationic Fluorinated Ether Silane Compositions

(71) Applicants: Stewart H. Corn, St. Paul, MN (US); Chetan P. Jariwala, Woodbury, MN (US); Suresh S. Iyer, Woodbury, MN (US)

(72) Inventors: Stewart H. Corn, St. Paul, MN (US); Chetan P. Jariwala, Woodbury, MN (US); Suresh S. Iyer, Woodbury, MN (US)

(73) Assignee: 3M INNOVATIVE PROPERTIES COMPANY, St. Paul, MN (US)

(21) Appl. No.: 13/881,895

(22) PCT Filed: Dec. 20, 2011
(86) PCT No.: PCT/US11/66159

§ 371 Date: Apr. 26, 2013

Related U.S. Application Data
(60) Provisional application No. 61/425,461, filed on Dec. 21, 2010.

(51) Int. Cl. B01D 39/16

(52) U.S. Cl. CPC B01D 39/163
USPC 210/505; 210/500.1; 55/522; 55/527; 55/523; 55/528; 427/244

(57) ABSTRACT

Filter media is treated with a composition comprising cationic fluorinated ether silanes to provide durable water- and/or oil-repellency properties.

### FIELD

This invention relates to filter media that has been treated with cationic fluorinated ether silanes and to methods of providing repellency properties to filter media using cationic fluorinated ether silanes.

### BACKGROUND

Filter media (for example, fibrous filter media comprising glass, ceramic, polymeric and/or paper fibers or membrane filters) is often used to remove liquid droplets of oil, water, or other substances from a stream of gas, liquid, or vapor. Such media is used in various filter applications such as, for example, in combustion engine positive crankcase ventilation systems, air compressors, natural gas recovery, face masks, and the like. However, without surface treatment, the filter media can rapidly become wetted with the liquid in the fluid stream, resulting in poor filter performance and shortened filter lifetime.

Filter media is therefore sometimes treated with fluorochemicals. For example, U.S. Pat. No. 4,449,030 (Giglia) describes a glass filter media made oleophobic by treatment with polytetrafluoroethylene (PTFE); U.S. Pat. No. 5,981,614 (Adelitta) describes a hydrophobic and oleophobic fluorochemical composition for use on filter media; and U.S. Patent Application Pub. No. 2010/0212272 (Sealey et al.) describes filter media including a perfluorocarbon. But, known fluorochemical treatments for filter media are often not very durable when exposed to the filter's working conditions such as high or fluctuating operating temperatures, vibration, and the presence of chemicals such as oil.

### SUMMARY

In view of the foregoing, we recognize that there is a need in the art for treated filter media that exhibits improved durability over media treated with conventional fluorochemical treatments.

Briefly, in one aspect, the present invention provides filter media treated with a composition comprising a silane compound of Formula Ia or Ib:

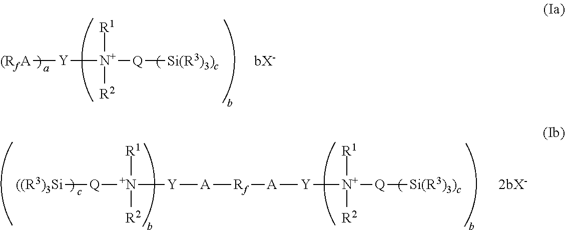

wherein

a, b, and c are independently integers from 1 to 3;

R_{f} is a perfluorinated ether group;

A is a linking group having the formula —C_{d}H_{2d}ZC_{g}H_{2g}—, wherein d and g are independently integers from 0 to 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group;

Y is a bridging group having 1 to 10 carbon atoms, a valency from 2 to 6, and comprising at least one of an alkylene group or an arylene group;

Q is a connecting group having 1 to 10 carbon atoms, a valency from 2 to 6, and comprising at least one of an alkylene group or an arylene group;

R¹ and R² are independently selected from the group consisting of a hydrogen atom, an alkyl group, an aryl group, and an aralkyl group;

each R³ is independently selected from the group consisting of hydroxy groups, alkoxy groups, acyl groups, acyloxy groups, halo groups, and polyether groups; and

X⁻ is a counter ion selected from the group consisting of inorganic anions, organic anions, and combinations thereof.

In another aspect, the present invention provides a filter media treated with a composition comprising a silane compound of Formula IIa:

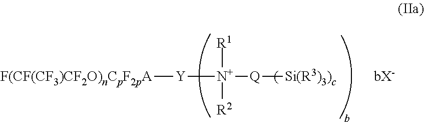

wherein

n is an integer from 2 to 12;

p is an integer from 1 to 6;

b and c are independently integers from 1 to 3;

A is a linking group having the formula —C_{d}H_{2d}ZC_{g}H_{2g}—, wherein d and g are independently integers from 0 to 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group;

Y is a bridging group comprising an alkylene group having 1 to 6 carbon atoms;

Q is a connecting group comprising an alkylene group having 1 to 6 carbon atoms;

R¹ and R² are independently alkyl groups having 1 to 4 carbon atoms;

each R³ is independently selected from the group consisting of hydroxy groups, methoxy groups, ethoxy groups, acetoxy groups, chloro groups, and polyether groups; and

X⁻ is a counterion selected from the group consisting of a halide, sulfate, phosphate, an alkanoate, an alkyl sulfonate, an aryl sulfonate, an alkyl phosphonate, an aryl phosphonate, a fluorinated alkanoate, a fluorinated alkyl sulfonate, a fluorinated aryl sulfonate, a fluorinated alkyl sulfonimide, a fluorinated alkyl methide, and combinations thereof.

In yet another aspect, the present invention provides a filter media treated with a composition comprising a compound of Formula IIb:

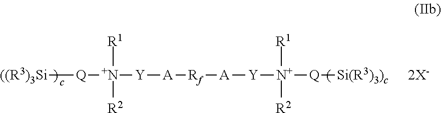

wherein

R_{f} has the structure —CF(CF₃)(OCF₂CF(CF₃))ₘOCF₂CF₂CF₂CF₂O(CF(CF₃)CF₂O)ₙCF(CF₃)—, wherein m is an integer from 1 to 12 and n is an integer from 2 to 10;

b and c are each independently an integer from 1 to 3;

A is a linking group having the formula —C_{d}H_{2d}ZC_{g}H_{2g}—, wherein d and g are independently integers from 0 to 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group;

Y is a bridging group comprising an alkylene group having 1 to 6 carbon atoms;

Q is a connecting group comprises an alkylene group having 1 to 6 carbon atoms;

R¹ and R² are independently alkyl groups having 1 to 4 carbon atoms;

each R³ is independently selected from the group consisting of hydroxy groups, methoxy groups, ethoxy groups, acetoxy groups, chloro groups, and polyether groups; and

X⁻ is a counter ion selected from the group consisting of a halide, sulfate, phosphate, an alkanoate, an alkyl sulfonate, an aryl sulfonate, an alkyl phosphonate, an aryl phosphonate, a fluorinated alkanoate, a fluorinated alkyl sulfonate, a fluorinated aryl sulfonate, a fluorinated alkyl sulfonimide, a fluorinated alkyl methide, and combinations thereof.

In yet another aspect, the present invention provides a method of providing repellency properties to filter media. The method comprises (a) providing a filter media, and (b) contacting the filter media with a composition comprising a silane compound of Formula Ia or Ib.

In still another aspect, the present invention provides a method of making a fibrous filter media having repellency properties comprising (a) providing fibers, (b) contacting the fibers with a composition comprising a silane compound of Formula Ia or Ib, and (c) drying the fibers to form a treated fibrous filter media.

Filter media of the invention, which is treated with cationic fluorinated ether silane compositions, shows improved durability over media treated with conventional fluorochemical treatments.

### DETAILED DESCRIPTION

As used herein,

The terms “a,” “an,” “the,” “at least one,” and “one or more” are used interchangeably. Thus, for example, a composition that comprises “a” compound of Formula I can be interpreted to mean that the composition includes “one or more” compounds of Formula I;

The term “perfluorinated ether group” refers to an ether group having at least one fluorine-to-carbon bond and being substantially free of hydrogen-to-carbon bonds;

The term “perfluoropolyether group” refers to a perfluorinated ether group comprising more than one perfluorinated ether group;

The term “perfluoroalkyl group” refers to an alkyl group having at least one fluorine-to-carbon bond and being substantially free of hydrogen-to-carbon bonds; and

The term “perfluoroalkylene group” refers to an alkylene group having at least one fluorine-to-carbon bond and being substantially free of hydrogen-to-carbon bonds.

### Filter Media

Any type of filter media may benefit from treatment with the cationic fluorinated ether silanes described below. The most common types of filters are fibrous filters and membrane filters.

Fibrous filters comprise fine fibers. Typically, the fiber diameter ranges from the submicron range up to about 100 mm. The fibrous filter media is highly porous in order to allow contaminated air, gas, liquid, or vapor to flow through the filter while the filter traps or holds back the contaminants. Common types of fibers used in fibrous filters include, for example, cellulose (paper/wood) fibers, glass fibers, ceramic fibers, and polymeric fibers (for example, polyester, nylon, and the like). Suitable fibrous filter media is described, for example, in U.S. Patent Application Pub. No. 2010/0212272 (Sealey et al.).

Membrane filters are typically less porous than fibrous filters. Membrane filter media often comprises cellulose esters, sintered metals, polyvinyl chloride, PTFE, and/or other plastics.

### Cationic Fluorinated Ether Silanes

The filter media of the invention is treated with a composition comprising a cationic fluorinated ether silane compound in order to provide durable water- and/or oil-repellency properties. In one embodiment, the silane compound is of Formula Ia or Ib:

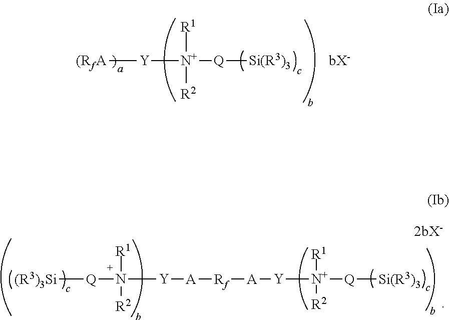

In other embodiments, the silane compound is of Formula IIa or IIb:

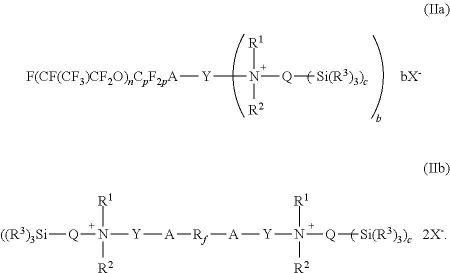

### Perfluorinated Ether Group R_{f}

The perfluorinated ether group comprises at least 1 carbon atom. The perfluorinated ether group may be a linear perfluorinated ether group, or it may comprise branched or cyclic structures. An oxygen atom in the perfluorinated ether group may be in one or more linear, branched, or cyclic structures. The perfluorinated ether group may have a weight average molecular weight of about 200 to about 7000, about 500 to about 5000, about 1000 to about 5000, about 1000 to about 4000, about 1000 to about 3000, or about 1000 to 1500. In some embodiments, the perfluorinated ether group has a weight average molecular weight of about 300, about 400, about 600, about 800, about 1000, about 1200, about 1400, about 1600, about 1800, about 2000, about 2200, about 2400, about 2600, about 2800, or about 3000.

The perfluorinated ether group may comprise a perfluoroalkyl group, a perfluoroalkylene group, or both. The perfluoroalkyl group may comprise linear, branched, or cyclic structures, or a combination of such structures. In some embodiments, the perfluoroalkyl group comprises more than one of a linear, branched, or cyclic structure. Non-limiting examples of perfluoroalkyl groups include perfluoromethyl, perfluoroethyl, perfluoropropyl, perfluorobutyl, perfluoro-2-butyl, perfluorohexyl, perfluorocyclohexyl, and perfluorocyclohexylmethyl groups. The perfluoroalkylene group may comprise linear, branched, or cyclic structures, or a combination of such structures. In some embodiments, the perfluoroalkylene group comprises more than one of a linear, branched, or cyclic structure. Non limiting examples of perfluoroalkylene groups include perfluoromethylene, perfluoroethylene, and perfluoro-1,2-propylene.

In some embodiments, the perfluorinated ether group is a perfluoropolyether group comprising at least two oxygen atoms.

The perfluorinated ether group may comprise a structure F(CₘF₂ₘO)ₙCₚF₂ₚ—, wherein m is an integer of at least about 1, n is an integer of at least about 2, and p is an integer of at least about 1. It is understood that the preparation of perfluorinated ethers comprising such structures may result in a mixture of perfluorinated ethers, each comprising structures having different integer values of m, n, and p. Such mixtures of perfluorinated ethers may have non-integer average values of m, n and p. In some embodiments, m is an integer from about 1 to about 12, n is an integer from about 2 to about 10, and p is an integer from about 1 to about 6. In some embodiments, m is an integer greater than about 2, greater than about 4, greater than about 6, greater than about 8, or greater than about 10. In some embodiments, n is an integer greater than about 2. In some embodiments, n is an integer greater than about 3, greater than about 4, greater than about 5, greater than about 6, greater than about 7, greater than about 8, or greater than about 9. In some embodiments, p is an integer from about 1 to about 10, about 1 to about 8, or about 1 to about 6. In some embodiments, p is an integer of 1, 2, 3, 4, 5, 6, 7, 8, 9, or 10. The substructures —CₘF₂ₘ— and —CₚF₂ₚ— may independently comprise one or more of a linear, branched, or cyclic structure.

The perfluorinated ether group may comprise a structure F(CF(CF₃)CF₂O)_{q}CF(CF₃)—, wherein q is an integer greater than about 1. It is understood that the preparation of perfluorinated ethers comprising such structures may result in a mixture of perfluorinated ethers each comprising structures having different integer value of q. Such mixtures of perfluorinated ethers may have non-integer average values of q. In some embodiments, q is an integer greater than about 2, greater than about 3, greater than about 4, greater than about 5, greater than about 6, greater than about 7, greater than about 8, greater than about 9, greater than about 10, greater than about 15, greater than about 20, or greater than about 25. In some embodiments, q is an integer from about 2 to about 12. The perfluorinated ether group may be derived from, for example, tetrafluoroethylene or hexafluoropropylene, as described in, for example, U.S. Pat. Nos. 3,882,193 (Rice, et al.) and 3,250,807 (Fritz et al.). The perfluorinated ether group may be derived from, for example, hexafluoropropylene oxide, as described in, for example, U.S. Pat. Nos. 6,923,921 (Flynn, et al.) and 3,250,808 (Moore, Jr., et al.).

### Linking Group A

Linking group A links the perfluorinated ether group R_{f} to the bridging group Y. Linking group A has a valency at least sufficient to link the perfluorinated ether group R_{f} to the bridging group Y. In some embodiments, linking group A has a valency of at least about 2. In some embodiments, linking group A has a valency of about 2. In some embodiments, linking group A has a valency from about 2 to about 6.

Linking group A may be formed as part of the perfluorinated ether group R_{f}, i.e., linking group A may be linked to perfluorinated ether group R_{f} before it is linked to bridging group Y. Alternatively, linking group A may be formed as part of bridging group Y and may be linked to bridging group Y before it is linked to perfluorinated ether group R_{f}. Alternatively, linking group A may be formed during a chemical reaction of a perfluorinated ether precursor compound and a bridging group Y precursor compound. In this embodiment, linking group A may be linked to perfluorinated ether group R_{f} and bridging group Y essentially at the same time. In some embodiments, linking group A may be divalent.

In some embodiments, the linking group A may have the formula —C_{d}H_{2d}ZC_{g}H_{2g}—, wherein d and g are independently integers from about 0 to about 10 and subgroup Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group. In some embodiments, d and g are independently integers from about 1 to about 4, and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group. In some embodiments, for example when d and g are both zero, linking group A is comprises subgroup Z. In some embodiments, at least one of d or g is at least 1, and Z is a covalent bond.

In some embodiments, for example when Z is a covalent bond, linking group A comprises an alkylene group. The alkylene group may comprise linear, branched, or cyclic structures. The alkylene group may further comprise at least one heteroatom, e.g., oxygen, nitrogen, or sulfur. The alkylene group may comprise at least about 1 carbon atom, or up to about 2, up to about 3, up to about 4, up to about 5, up to about 6, up to about 7, up to about 8, up to about 9, up to about 10, up to about 14, up to about 16, up to about 18, or up to about 20 carbon atoms. Non-limiting examples of alkylene groups include methylene, ethylene, 1,3-propylene, 1,2-propylene, 1,4-butylene, 1,4-cyclohexylene, and 1,4-cyclohexyldimethylene.

In some embodiments, linking group A further comprises an arylene group. The arylene group comprises one or more aromatic rings. When the arylene group comprises more than one aromatic ring, the aromatic rings (which may be the same or different) may be fused, joined by a covalent bond, or joined via, for example, a joining group such as an alkylene group or a heteroatom such as oxygen. The arylene group may comprise at least one heteroatom, e.g., oxygen, nitrogen, or sulfur. The arylene group may comprise at least about 4 carbon atoms, or at least about 5, at least about 6, at least about 10, or at least about 14 carbon atoms. Non-limiting examples of arylene groups include phenyl, 1-naphthyl, 2-naphthyl, 9-anthracenyl, furanyl, and thiophenyl.

In some embodiments, linking group A may comprise an aralkylene group. In some embodiments, linking group A may comprise an alkarylene group.

### Bridging Group Y

Bridging group Y bridges the linking group A and the cationic nitrogen atom. Bridging group Y has a valency at least sufficient to bridge the linking group A and the cationic nitrogen atom. For example, bridging group Y may have a valency of at least about 1+b. In some embodiments, bridging group Y has a valency of about 2. In some embodiments, bridging group Y has a valency of greater than about 2. In some embodiments, bridging group Y has a valency from about 2 to about 6. Bridging group Y may have a valency from about 2 to about 6, may comprise about 1 to about 10 carbon atoms, and may comprise at least one of an alkylene group or an arylene group.

Bridging group Y may be formed as part of a group comprising the cationic nitrogen atom. Alternatively, it may be formed as part of a group comprising a nitrogen atom that will be later quaternized to form the cationic nitrogen atom. Alternatively, it may be formed during a chemical reaction of a linking group A precursor compound and a nitrogen containing compound. In this embodiment, bridging group Y may bridge linking group A and a neutral or cationic nitrogen atom essentially at the same time. In some embodiments, bridging group Y may be divalent.

In some embodiments, bridging group Y comprises an alkylene group. The alkylene group may comprise linear, branched, or cyclic structures. The alkylene group may comprise at least one heteroatom, e.g., oxygen, nitrogen, or sulfur. The alkylene group may comprise at least about 1 carbon atom, or up to about 2, up to about 3, up to about 4, up to about 5, up to about 6, up to about 7, up to about 8, up to about 9, up to about 10, up to about 14, up to about 16, up to about 18, or up to about 20 carbon atoms. The alkylene group may comprise more than about 20 carbon atoms. Non-limiting examples of alkylene groups include methylene, ethylene, 1,3-propylene, 1,2-propylene, 1,4-butylene, 1,4-cyclohexylene, and 1,4-cyclohexyldimethylene.

In some embodiments, bridging group Y comprises an arylene group. The arylene group comprises one or more aromatic rings. When the arylene group comprises more than one aromatic ring, the aromatic rings (which may be the same or different) may be fused, joined by a covalent bond, or joined via, for example, a joining group such as an alkylene group or a heteroatom such as oxygen. The arylene group may comprise at least one heteroatom, e.g., oxygen, nitrogen, or sulfur. The arylene group may comprise at least about 4 carbon atoms, or at least about 5, at least about 6, at least about 10, or at least about 14 carbon atoms. Non-limiting examples of arylene groups include phenyl, 1-naphthyl, 2-naphthyl, 9-anthracenyl, furanyl, and thiophenyl.

In some embodiments, bridging group Y comprises an aralkylene group or an alkarylene group. The aralkylene or alkarylene group may comprise one or more aromatic rings. When the aralkylene or alkarylene group comprises more than one aromatic ring, the aromatic rings (which may be the same or different) may be fused, joined by a covalent bond, or joined via, for example, a joining group such as an alkylene group or a heteroatom such as oxygen. The aralkylene or alkarylene group may comprise at least one heteroatom, e.g., oxygen, nitrogen, or sulfur. The aralkylene or alkarylene group may comprise at least about 4 carbon atoms, or at least about 5, at least about 6, at least about 10, or at least about 14 carbon atoms.

### Connecting Group Q

Connecting group Q connects the cationic nitrogen atom to the silicon atom. Connecting group Q has a valency at least sufficient to connect the cationic nitrogen atom to the silicon atom. For example, connecting group Q has a valency of at least about c+1. In some embodiments, connecting group Q has a valency of about 2. In some embodiments, connecting group Q has a valency of greater than about 2. In some embodiments, connecting group Q has a valency from about 2 to about 6. Connecting group Q may have a valency from about 2 to about 6, may comprise about 1 to about 10 carbon atoms, and may comprise at least one of an alkylene group or an arylene group.

Connecting group Q may be formed as part of a group comprising the cationic nitrogen atom. Alternatively, it may be formed as part of a group comprising a silicon atom. Alternatively, it may be formed during a chemical reaction of a nitrogen-containing compound and a silicon containing compound. In this embodiment, connecting group Q connects a neutral or cationic nitrogen atom and a silicon atom essentially at the same time. In some embodiments, connecting group Q may be divalent.

In some embodiments, connecting group Q comprises an alkylene group. The alkylene group may comprise linear, branched, or cyclic structures. The alkylene group may comprise at least one heteroatom, e.g., oxygen, nitrogen, or sulfur. The alkylene group may comprise at least about 1 carbon atom, or up to about 2, up to about 3, up to about 4, up to about 5, up to about 6, up to about 7, up to about 8, up to about 9, up to about 10, up to about 14, up to about 16, up to about 18, or up to about 20 carbon atoms. In some embodiments, connecting group Q comprises at least one oxyalkylene group. In some embodiments, connecting group Q comprises a poly(oxyalkylene) group, for example, a poly(oxyethylene) group. The alkylene group may comprise more than about 20 carbon atoms. Non-limiting examples of alkylene groups include methylene, ethylene, 1,3-propylene, 1,2-propylene, 1,4-butylene, 1,4-cyclohexylene, and 1,4-cyclohexyldimethylene.

In some embodiments, connecting group Q comprises an arylene group. The arylene group comprises one or more aromatic rings. When the arylene group comprises more than one aromatic ring, the aromatic rings (which may be the same or different) may be fused, joined by a covalent bond, or joined via, for example, a joining group such as an alkylene group or a heteroatom such as oxygen. The arylene group may comprise at least one heteroatom, e.g., oxygen, nitrogen, or sulfur. The arylene group may comprise at least about 4 carbon atoms, or at least about 5, at least about 6, at least about 10, or at least about 14 carbon atoms. Non-limiting examples of arylene groups include phenyl, 1-naphthyl, 2-naphthyl, 9-anthracenyl, furanyl, and thiophenyl.

In some embodiments, connecting group Q comprises an aralkylene or an alkarylene group. The aralkylene or alkarylene group may comprise one or more aromatic rings. When the aralkylene or alkarylene group comprises more than one aromatic ring, the aromatic rings (which may be the same or different) may be fused, joined by a covalent bond, or joined via, for example, a joining group such as an alkylene group or a heteroatom such as oxygen. The aralkylene or alkarylene group may comprise at least one heteroatom, e.g., oxygen, nitrogen, or sulfur. The aralkylene or alkarylene group may comprise at least about 4 carbon atoms, or at least about 5, at least about 6, at least about 10, or at least about 14 carbon atoms.

### R¹, R², and R³

In the compounds of Formulae Ia, Ib, IIa, and IIb, R¹ and R² are bonded to the cationic nitrogen atom. Each R¹ and R² may be independently selected from the group consisting of a hydrogen atom, an alkyl group, an aryl group and an aralkyl group.

When either or both of R¹ or R² is an alkyl group, the alkyl group may comprise about 1 carbon atom, more than about 1 carbon atom, more than about 2 carbon atoms, more than about 4 carbons atoms, more than about 6 carbon atoms, more than about 8 carbon atoms, more than about 10 carbon atoms, more than about 16 carbon atoms, or more than about 20 carbon atoms. In some embodiments, the alkyl group comprises 1 to 8 carbon atoms. In some embodiments, the alkyl group comprises a straight chain alkyl group. In other embodiments, the alkyl group comprises a branched alkyl group. In still other embodiments, the alkyl group comprises a cyclic alkyl group. When each of R¹ and R² comprises an alkyl group, R¹ and R² may comprise the same alkyl group, or R¹ and R² may comprise different alkyl groups. Non-limiting examples of alkyl groups include methyl, ethyl, 1-propyl, iso-propyl, butyl, iso-butyl, sec-butyl, pentyl, iso-pentyl, neo-pentyl, hexyl, 2-ethylhexyl, octyl, decyl, undecyl, dodecyl, tetradecyl, pentadecyl, octadecyl, cyclohexyl, 4-methylcyclohexyl, cyclohexylmethyl, cyclopenyl, and cyclooctyl.

When either or both of R¹ or R² is an aryl group, the aryl group may comprise one arene ring or more than one arene ring. Arene rings may comprise up to 6 carbon atoms, up to 8 carbon atoms, up to 10 carbon atoms, up to 12 carbon atoms, up to 14 carbon atoms, up to 16 carbon atoms, or up to 18 carbon atoms. Arene rings may comprise a heteroatom, for example, nitrogen, oxygen, or sulfur. If more than one arene ring is present in an aryl group, the arene rings may be fused together, or they may be joined by a chemical bond. When each of R¹ and R² comprises an aryl group, re and R² may comprise the same aryl group or different aryl groups. Non-limiting examples of aryl groups include substituted and unsubstituted phenyl, 1-naphthyl, 2-naphthyl, 9-anthracenyl, and biphenyl.

When either or both of R¹ or R² are an aralkyl group, the aralkyl group may comprise one arene ring or more than one arene ring. The aralkyl group may comprise up to 6 carbon atoms, up to 8 carbon atoms, up to 10 carbon atoms, up to 12 carbon atoms, up to 14 carbon atoms, up to 16 carbon atoms, up to 18 carbon atoms, or up to 20 carbon atoms. If more than one arene ring is present in the aralkyl group, the arene rings may be fused together, or they may be joined by a chemical bond. Arene rings may comprise a heteroatom, for example, nitrogen, oxygen, or sulfur. When each of R¹ and R² comprises an aralkyl group, R¹ and R² may comprise the same aralkyl group, or R¹ and R² may comprise different aralkyl groups. Non-limiting examples of aralkyl groups include benzyl, 1-phenylethyl, 2-phenylethyl, 3-phenylpropyl, 2-naphthylethyl, and 9-anthracenylmethyl.

In the compounds of Formulae Ia, Ib, IIa, and IIb, each R³ is independently bonded to the silicon atom. In some embodiments, each R³ is independently selected from the group consisting of hydroxy groups, alkoxy groups, acyl groups, acyloxy groups, halo groups, and polyether groups. In some embodiments, at least one R³ is independently bonded to the silicon atom via a hydrolyzable bond. In this context, “bonded via a hydrolyzable bond” refers to the reactivity of the R³-silicon bond with water, i.e., it is a bond that is capable of undergoing a hydrolysis reaction. In some embodiments, R³ is bonded to the silicon atom via a bond including an carbon atom, i.e., R³ comprises an carbon atom bonded to the silicon atom. In some embodiments, R³ is bonded to the silicon atom via a bond including an atom other than a carbon atom. In some embodiments, R³ is bonded to the silicon atom via a bond including an oxygen atom, i.e., R³ comprises an oxygen atom bonded to the silicon atom. In some embodiments, R³ is bonded to the silicon atom via a bond including a nitrogen atom, i.e., R³ comprises a nitrogen atom bonded to the silicon atom.

Each R³ may independently be a non-ionic group or an ionic group. The ionic group may be cationic, anionic, or zwitterionic. Non-limiting examples of non-ionic groups include hydroxy, alkoxy, acyl, acyloxy, halo, and polyether groups. Alkoxy groups include, for example, methoxy and ethoxy groups. Halo groups include, for example, chloro, bromo, and iodo groups. Acyl groups include, for example, acetyl, propionyl, and benzoyl groups. Acyloxy groups include, for example, acetoxy and propionoxy groups. Polyether groups may comprise oxyalkylene groups, for example groups having the formula (OCᵥH₂ᵥ), where v is an integer from about 1 to about 6. Non-limiting examples of polyether groups comprising oxyalkylene groups include poly(oxymethylene), poly(oxyethylene), and poly(oxybutylene) groups. In some embodiments, the polyether group comprises about 1 to about 200 oxyalkylene groups. In some embodiments, the polyether group comprises about 1 to about 5, about 1 to about 10, about 1 to about 20, about 1 to about 30, about 1 to about 40, or about 1 to about 50 oxyalkylene groups.

Non-limiting examples of ionic groups include groups such as —OCH₂CH₂N⁺(CH₃)₃I⁻, —OCH₂CH₂N⁺(CH₃)₃Cl⁻, and —OCH₂CH₂N⁺(CH₃)₂CH₂CH₂CH₂SO₃⁻. In some embodiments, polyether groups comprising more than one oxyalkylene group further comprises a cationic group (e.g., a group comprising a cationic nitrogen atom), an anionic group, or both a cationic group and an anionic group.

### Counter Ion X⁻

Counter ion X⁻ may comprise an organic anion, an inorganic anion, or a combination of organic and inorganic anions. In some embodiments, counter ion X⁻ may result from a chemical reaction that forms the cationic nitrogen atom, for example a reaction between an amine and an alkylating agent such as, for example, a chloroalkylsilane, that forms a nitrogen to carbon bond and displaces a chloride ion. In some embodiments, counter ion X⁻ may result from the protonation of an amine with an acid. Such a reaction can provide a cationic nitrogen atom and the conjugate base of the acid (i.e., the counter ion X⁻). In some embodiments, counter ion X⁻ may result from an ion exchange reaction, e.g., a reaction in which one anion is exchanged for another.

In some embodiments, counter ion X⁻ may be selected from the group consisting of a halide (e.g., chloride, bromide, or iodide), sulfate, phosphate, an alkanoate (e.g., acetate or propionate), an alkyl sulfonate, an aryl sulfonate (e.g., benzenesulfonate), an alkyl phosphonate, an aryl phosphonate, a fluorinated alkanoate (e.g., trifluoroacetate), a fluorinated alkyl sulfonate (e.g., trifluormethanesulfonate), a fluorinated aryl sulfonate (e.g., 4-fluorophenylsulfonate), a fluorinated alkyl sulfonimide (e.g., bis(trifluoromethylsulfonyl)imide, a fluorinated alkyl methide (e.g., tris(trifluoromethylsulfonyl)methide, and combinations thereof.

### Solvents

The compositions of the invention may comprise at least one water-soluble organic solvent. The compositions of the invention may comprise less than about 1 weight percent to more than about 99 weight percent water-soluble organic solvent. The compositions may comprise less than about 1 weight percent, more than about 1 weight percent, more than about 5 weight percent, more than about 10 weight percent, more than about 20 weight percent, more than about 30 weight percent, more than about 40 weight percent, more than about 50 weight percent, more than about 60 weight percent, more than about 70 weight percent, more than about 80 weight percent, more than about 90 weight percent, or more than about 99 weight percent water soluble organic solvent.

The water-soluble organic solvent may be soluble in water in all proportions of organic solvent and water. The water-soluble organic solvent may be soluble in water up to about 1 weight percent, up to about 2 weight percent, up to about 5 weight percent, up to about 10 weight percent, up to about, 20 weight percent, up to about 30 weight percent, up to about 40 weight percent, up to about 50 weight percent, up to about 60 weight percent, up to about 70 weight percent, up to about 80 weight percent, or up to about 90 weight percent organic solvent in water. The water-soluble organic solvent may be soluble in water up to more than about 90 weight percent organic solvent in water. Suitable organic solvents include ketones (e.g., acetone), ethers (e.g., dimethoxyethane, tetrahydrofuran), esters (e.g., methyl acetate), carbonates (e.g., propylene carbonate), amides (e.g., dimethylacetamide), sulfoxides (e.g., dimethylsulfoxide), sulfones (e.g., sulfolane), and alcohols (e.g., ethanol, isopropanol, n-propanol). In some embodiments, the water-soluble organic solvent comprises one or more of butoxyethanol, methoxyethanol, propylene glycol monopropyl ether, and 1-methoxy-2-propanol. In some embodiments, the water-soluble organic solvent comprises a solvent used to prepare a compound of Formula Ia, Ib, IIa, or IIb. In some embodiments, the water-soluble comprises a solvent not used to prepare a compound of Formula Ia, Ib, IIa, or IIb, for example a solvent that may be added to the composition. In some embodiments, the water-soluble organic solvent may be added to the composition during a processing or formulation step, for example during a solvent exchange process.

The composition of the invention may comprise water. Water may be present from less than about 1 to more than about 99 weight percent of the composition. In some embodiments, water is present at more than about 1 weight percent, or more than about 10, more than about 20, more than about 30, more than about 40, more than about 50, more than about 60, more than about 70, more than about 80, more than about 90, more than about 95, more than about 97, more than about 98, or more than about 99 weight percent of the composition.

The composition of the invention may comprise water and a water-soluble organic solvent. The weight ratio of water to water-soluble organic solvent may be from less than 1 to 99 to more than 99 to 1. In some embodiments, the weight ratio of water to water-soluble organic solvent can be at least about 1 to about 99, about 2 to about 98, about 5 to about 95, about 10 to about 90, about 15 to about 85, about 20 to about 80, about 30 to about 70, about 40 to about 50, about 50 to about 50, about 60 to about 40, about 70 to about 30, about 80 to about 20, about 90 to about 10, about 95 to about 5, about 98 to about 2, or about 99 to about 1.

The concentration of a compound of Formula Ia, Ib, IIa, or IIb in a mixture of water and/or a water soluble organic solvent may be less than about 99 weight percent, less than about 90 weight percent, less than about 80 weight percent, less than about 70 weight percent, less than about 60 weight percent, less than about 50 weight percent, less than about 40 weight percent, less than about 30 weight percent, less than about 20 weight percent, or less than about 10 weight percent. In some embodiments, concentration of a compound of Formula Ia, Ib, IIa, or IIb in a mixture of a water soluble organic solvent and water is less than about 9, less than about 8, less than about 7, less than about 6, less than about 5, less than about 4, less than about 3, less than about 2, less than about 1, or less than about 0.5 weight percent. In various embodiments, the weight ratio of water to water-soluble organic solvent is more than about 90 to about 10. In various embodiments, the concentration of at least one compound of Formula Ia, Ib, IIa, or IIb is less than about 10 weight percent, less than about 6 weight percent, less than about 5 weight percent, less than about 4 weight percent, less than about 2 weight percent, or less than about 1 weight percent. In some embodiments, the concentration is between about 0.05 and about 1 weight percent.

Method of Providing Repellency Properties to Fibrous Filter Media The compositions comprising cationic fluorinated ether silanes of Formula Ia, Ib, IIa, or IIb can be used to provide filter media with water- and/or oil-repellency properties by contacting the filter media with the composition. For example, the filter media can be dipped into the composition or the composition can be coated (for example, by roller, knife, or the like), padded, foamed or sprayed on the filter media. The treated filter media can be allowed to air dry at room temperature. Alternatively, loose fibers and optionally binder can be added to the composition and mixed. The treated fibers can then be strained out on a screen and pressed to remove excess liquid. The resulting fiber sheet can be dried to form the finished treated filter media. Optionally, the treated filter media may be heat cured.

The silane compound can be present on the filter media in an amount between about 0.05% and about 10% by weight solids as determined gravimetrically. In some embodiments, the silane compound is present on the filter media in an amount of 5% by weight solids or less, 3% by weight solids or less, 2% by weight solids or less, 1% by weight solids or less, or 0.5% by weight solids or less. In some embodiments, the silane compound may not be detectable gravimetrically, but may still be present in an effective amount.

Surprisingly, treated filter media exhibits good repellency properties even after being exposed to simulated process conditions (that is, they exhibit good durability).

### Examples

Objects and advantages of this invention are further illustrated by the following examples, but the particular materials and amounts thereof recited in these examples, as well as other conditions and details, should not be construed to unduly limit this invention.

### Materials

Materials utilized in the examples are shown in Table 1.

TABLE 1
Materials List

| Compound | Source | Chemical |
|---|---|---|
| PM-870 | 3M Company, St. Paul, MN | Fluorochemical polyester |
| PM-490 | 3M Company, St. Paul, MN | Fluorochemical polyurethane |
| PM-3630 | 3M Company, St. Paul, MN | Fluorochemical polyurethane |
| PM-3633 | 3M Company, St. Paul, MN | Fluorochemical polyurethane |
| L-20823 | 3M Company, St. Paul, MN | Fluorochemical polyester |
| HFPO | 3M Company, St. Paul, MN | C₃F₇O[CF(CF₃)CF₂O]ₙCF(CF₃)— |
| HFPO-quatenary Silane | 3M Company, St. Paul, MN | 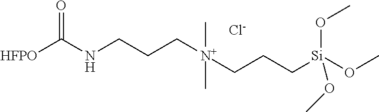 |
| C6-quatenary Silane | Prepared as described below | 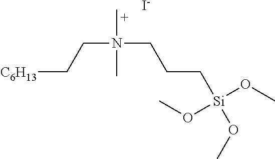 |
| C4-quatenary Silane | Prepared as described below | 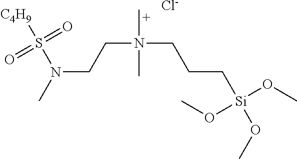 |
| IPA | EMD, Gibbstown, NJ | Isopropanol |
| Mineral Spirits | Calumet, Indianapolis, IN | Aliphatic solvent mixture |
| Heptane | EMD, Gibbstown, NJ | Heptanes |
| Filter Medium A | Donaldson Company, | 50% polyester/50% glass fibers |
| | Bloomington, MN | |
| Filter Medium B | Lydall Co, Rochester, NY | 100% glass fibers (binderless, |
| | | wetlaid) |
| Filter Medium C | Cerex Advanced Fabrics, | 100% nylon fibers (Cerex Type 23 |
| | Cantonment, FL | spunbond 68 g/m²) |
| Filter Medium D | Whatman plc, Maidstone, Kent, | 100% cellulose fibers (Whatman #40 |
| | UK | ashless filter paper) |

### Test Methods

### Oil Repellency

Oil Repellency was determined according to AATCC Test Method 118-2007, “Oil Repellency: Hydrocarbon Resistance Test”. Test specimens were cut into 6.4 cm×10.2 cm strips. The standard test liquids were obtained from 3M Company.

### Water Repellency

Water Repellency was determined similar to AATCC Test Method 193-2007, “Aqueous Liquid Repellency Water/Alcohol Solution Resistance Test” except that the test liquids were per the water/isopropanol ratios in Table 2 below. For test specimens that did not show repellency using test liquid 0, a value of −1 was recorded. Test specimens were cut into 6.4 cm×10.2 cm strips. The test liquids were obtained from 3M Company.

TABLE 2
Water Repellency Test Liquids

| | Water/isopropanol | Surface Tension |
|---|---|---|
| Test Liquid | Ratio | (dynes/cm) |
| 0 | 100/0 | 72.8 |
| 1 | 90/10 | 39.0 |
| 2 | 80/20 | 32.0 |
| 3 | 70/30 | 28.3 |
| 4 | 60/40 | 26.6 |
| 5 | 50/50 | 25.0 |
| 6 | 40/60 | 24.3 |
| 7 | 30/70 | 23.7 |
| 8 | 20/80 | 23.3 |
| 9 | 10/90 | 22.4 |
| 10 | 0/100 | 21.7 |

### Examples

### E-1-E-12

HFPO-quatenary silane was prepared according to WO/2009/045771 (Dams et al.). The HFPO-quat silane was diluted to 50% (w/w) with IPA, then further diluted in water to make treatment baths of 1% solids or less. Filter media was dipped into these solutions for about 1 minute and allowed to drip-dry overnight. The next day, the filter media was dried completely at room temperature or heated to 120° C. for 20 minutes. The filter media was weighed prior to dip coating and after drying to determine the % by weight solids on fiber (SOF); because of the small sample sizes used, SOF could not always be detected. The treated filter media was equilibrated for 4 hours at 21° C. and 60% RH prior to testing for oil and water repellency.

Oil soaking was utilized to assess the durability of the treated polymer on filter media. After the initial oil and water repellency test, filter media was soaked in petroleum-based air compressor oil (Texaco Regal R&O 68) for 24 hours at 90° C. After soaking, the oil/filter media mixture was shaken on a shaker table for 24 hours (low speed, Filter Media A or 4 hours (high speed, Filter Media C and D) at 20° C. The filter media was removed from the oil and rinsed 3-5 times with mineral spirits, then twice with heptane. The filter media was then dried at room temperature and equilibrated for 4 hours at 21° C. and 60% RH prior to oil and water repellency testing.

### Comparatives Examples

Filter media was treated with several different fluorinated polymers listed in Table 1. Comparative examples were prepared as described below.

### Synthesis of C4-Quat Silane

### Comparative Example

A 250 mL round bottom flask was equipped with magnetic stirbar, reflux condenser and N₂ inlet was charged with C₄F₉SO₂N(CH₃)—CH₂CH₂—N(CH₃)₂ (5 g, 0.0130 moles) (this was prepared as in Mader et. al. US 2010/0084343 A1) and Cl—CH₂CH₂CH₂—Si(OCH₃)₃ (2.5 g, 1 molar equivalent) and was heated to 140° C. for 16 hours. The reaction mixture was cooled to room temperature and diluted with IPA to desired amount and was used for coating.

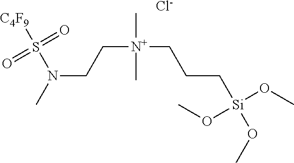

### Synthesis of C6-Quat Silane

### Comparative Example

A 250 mL round bottom flask was equipped with magnetic stirbar, reflux condenser and N2 inlet was charged with C₆F₁₃CH₂CH₂I (4.73 g, 0.01 moles) and N(CH₃)₂—CH₂CH₂CH₂—Si(OCH₃)₃ (2.05 g, 0.01 moles) and heated to 90° C. for 16 hours. The reaction mixture was cooled to room temperature and diluted with IPA to desired amount and was used for coating.

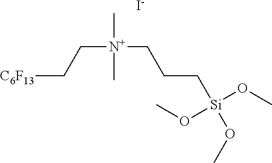

Isopropanol solutions of these quat silanes were further diluted in water, as above. Fluorochemical emulsions (designated PM or L in Table 1 above) were diluted in water only. Filter media were treated with these comparative treatments as described above, and tested in the same manner. In addition, uncoated filter media was tested for oil and water repellency.

### Results

Oil repellency (OR) and water repellency (WR) of the Examples (E) and Comparatives (C) on Filter Media A, B, C and D are shown in Tables 3, 4, 5 and 6, respectively. The oil soak test was not performed on filter media B; the % SOF was not determined on filter media C and D.

TABLE 3
Repellency of Treated Filter Medium A

| | | | | | Before | | | |
|---|---|---|---|---|---|---|---|---|
| | | Treatment | | Drying | Oil | | After Oil | |
| Example | | bath % | SOF | temp | Soak | | Soak | |
| No. | Treatment | solids | (wt. %) | (° C.) | OR | WR | OR | WR |
| E-1 | HFPO-quat Silane | 0.5 | 2.4 | 20 | 7 | 2 | 5 | 3 |
| E-2 | HFPO-quat Silane | 1.0 | 5 | 20 | 8 | 2 | 6 | 3 |
| E-3 | HFPO-quat Silane | 0.5 | 3.0 | 120 | 7 | 3 | 6 | 3 |
| E-4 | HFPO-quat Silane | 0.5 | 2.9 | 20 | 8 | 2 | 6 | 3 |
| E-5 | HFPO-quat Silane | 0.25 | 1.3 | 120 | 7 | 3 | 6 | 3 |
| E-6 | HFPO-quat Silane | 0.25 | 1.3 | 20 | 7 | 2 | 6 | 3 |
| E-7 | HFPO-quat Silane | 0.125 | 0.5 | 120 | 7 | 4 | 6 | 3 |
| E-8 | HFPO-quat Silane | 0.125 | 0.5 | 20 | 7 | 2 | 6 | 3 |
| E-9 | HFPO-quat Silane | 0.075 | 0.3 | 120 | 7 | 6 | 6 | 3.5 |
| E-10 | HFPO-quat Silane | 0.075 | 0.3 | 20 | 7 | 2 | 6 | 3.5 |
| E-11 | HFPO-quat Silane | 0.05 | 0.2 | 120 | 7 | 7 | — [a] | — |
| E-12 | HFPO-quat Silane | 0.05 | 0.1 | 20 | 6 | 2 | — | — |
| C-1 | PM-490 | 0.6 | 2.6 | 120 | 8 | 8 | 0 | 2 |
| C-2 | PM-490 | 1.2 | 10 | 120 | 8 | 9 | 1 | 2 |
| C-3 | PM-870 | 0.6 | 4.8 | 120 | 1.5 | 6 | 0 | 1 |
| C-4 | PM-870 | 1.2 | 7.7 | 120 | 1.5 | 6 | 0 | 0 |
| C-5 | L-20823 | 0.4 | 2.6 | 120 | 6 | 5 | 0 | 1 |
| C-6 | L-20823 | 0.8 | 5.1 | 120 | 6 | 5 | 0 | 1 |
| C-7 | PM-3630 | 0.5 | 2.5 | 120 | 7 | 9 | 0.5 | 3 |
| C-8 | PM-3630 | 1.0 | 5.1 | 120 | 7 | 9 | 0.5 | 3 |
| C-9 | PM-3633 | 0.5 | 5.1 | 120 | 6 | 6 | 0 | 2 |
| C-10 | PM-3633 | 1.0 | 7.7 | 120 | 6 | 7 | 0 | 1.5 |
| C-11 | C4-quat silane | 0.5 | 1.9 | 120 | 4 | 2 | — | — |
| C-12 | C4-quat silane | 0.5 | 0.6 | 20 | 2 | 1.5 | — | — |
| C-13 | C4-quat silane | 0.25 | 0.1 | 120 | 2 | 2 | — | — |
| C-14 | C4-quat silane | 0.25 | 0.8 | 20 | 2 | 2 | — | — |
| C-15 | C4-quat silane | 0.05 | 0.0 [c] | 120 | 0 | 2 | — | — |
| C-16 | C4-quat silane | 0.05 | 0.0 | 20 | 0 | 1 | — | — |
| C-17 | C6-quat silane | 0.5 | 0.5 | 120 | 5 | 2.5 | — | — |
| C-18 | C6-quat silane | 0.5 | 1.1 | 20 | 5 | 2 | — | — |
| C-19 | C6-quat silane | 0.25 | 0.2 | 120 | 2 | 2 | — | — |
| C-20 | C6-quat silane | 0.25 | 0.2 | 20 | 3 | 2 | — | — |
| C-21 | C6-quat silane | 0.05 | 0.0 | 120 | 0 | 1 | — | — |
| C-22 | C6-quat silane | 0.05 | 0.0 | 20 | 0 | 1 | — | — |
| C-23 | Untreated Filter | 0 | 0 | — | 0 | −1 [b] | — | — |
| | Medium A | | | | | | | |

[a] Not tested
[b] Failed test with 100% water
[c] Not detected

TABLE 4
Repellency of Treated Filter Medium B

| | | Treat- | | | | |
|---|---|---|---|---|---|---|
| | | ment | SOF | Drying | | |
| Example | | bath % | (wt. | temp | | |
| No. | Treatment | solids | %) | (° C.) | OR | WR |
| E-3 | HFPO-quat Silane | 0.5 | 2.1 | 120 | 7 | 2 |
| E-4 | HFPO-quat Silane | 0.5 | 2.7 | 20 | 6 | 2 |
| E-5 | HFPO-quat Silane | 0.25 | 0.7 | 120 | 7 | 3 |
| E-6 | HFPO-quat Silane | 0.25 | 1.2 | 20 | 7 | 2 |
| E-11 | HFPO-quat Silane | 0.05 | 0.0 [a] | 120 | 6 | 8 |
| E-12 | HFPO-quat Silane | 0.05 | 0.0 | 20 | 6 | 8 |
| C-11 | C4-quat silane | 0.5 | 1.7 | 120 | 1 | 2 |
| C-12 | C4-quat silane | 0.5 | 1.7 | 20 | 1 | 2 |
| C-13 | C4-quat silane | 0.25 | 0.7 | 120 | 0 | 2 |
| C-14 | C4-quat silane | 0.25 | 0.7 | 20 | 0 | 2 |
| C-15 | C4-quat silane | 0.05 | 0.0 | 120 | 0 | 1 |
| C-16 | C4-quat silane | 0.05 | 0.0 | 20 | 0 | 2 |
| C-17 | C6-quat silane | 0.5 | 0.5 | 120 | 2 | 1.5 |
| C-18 | C6-quat silane | 0.5 | 1.0 | 20 | 2 | 2 |
| C-19 | C6-quat silane | 0.25 | 0.1 | 120 | 0 | 0 |
| C-20 | C6-quat silane | 0.25 | 0.2 | 20 | 0 | 0 |
| C-21 | C6-quat silane | 0.05 | 0.0 | 120 | 0 | 0 |
| C-22 | C6-quat silane | 0.05 | 0.0 | 20 | 0 | 0 |
| C-24 | Untreated Filter | 0 | 0 | — [b] | 0 | −1 [c] |
| | Medium B | | | | | |

[a] Not detected
[b] Not tested
[c] Failed test with 100% water

TABLE 5
Repellency of Treated Filter Medium C

| | | | | |
|---|---|---|---|---|
| | Treat- | | | |
| Exam- | ment | Drying | Before Oil | After Oil |
| ple | bath % | temp | Soak | Soak |

| No. | Treatment | solids | (° C.) | OR | WR | OR | WR |
|---|---|---|---|---|---|---|---|
| E-3 | HFPO-quat | 0.5 | 120 | 6 | 2.5 | 6 | 1 |
| | Silane | | | | | | |
| E-4 | HFPO-quat | 0.5 | 20 | 7 | 1 | — [a] | — |
| | Silane | | | | | | |
| E-5 | HFPO-quat | 0.25 | 120 | 6 | 2 | — | — |
| | Silane | | | | | | |
| E-6 | HFPO-quat | 0.25 | 20 | 6 | 0 | — | — |
| | Silane | | | | | | |
| E-11 | HFPO-quat | 0.05 | 120 | 6 | 0 | — | — |
| | Silane | | | | | | |
| E-12 | HFPO-quat | 0.05 | 20 | 6 | −1 [b] | — | — |
| | Silane | | | | | | |
| C-25 | PM-490 | 0.5 | 120 | 8 | 7 | 2 | 2 |
| C-26 | PM-490 | 0.5 | 20 | 6 | 2 | — | — |
| C-27 | Untreated | 0 | 0 | 0 | 0 | — | — |
| | Filter | | | | | | |
| | Medium C | | | | | | |

[a] Not Tested
[b] Failed test with 100% water

TABLE 6
Repellency of Treated Filter Medium D

| | | Treat- | | Before | | | |
|---|---|---|---|---|---|---|---|
| Exam- | | ment | Drying | Oil | | After Oil | |
| ple | | bath % | temp | Soak | | Soak | |
| No. | Treatment | solids | (° C.) | OR | WR | OR | WR |
| E-3 | HFPO-quat | 0.5 | 120 | 6 | 1 | 5 | −1 [a] |
| | Silane | | | | | | |
| E-4 | HFPO-quat | 0.5 | 20 | 6 | −1 | — [b] | — |
| | Silane | | | | | | |
| E-5 | HFPO-quat | 0.25 | 120 | 6 | 1 | — | — |
| | Silane | | | | | | |
| E-6 | HFPO-quat | 0.25 | 20 | 6 | −1 | — | — |
| | Silane | | | | | | |
| E-11 | HFPO-quat | 0.05 | 120 | 1 | 0 | — | — |
| | Silane | | | | | | |
| E-12 | HFPO-quat | 0.05 | 20 | 2 | −1 | — | — |
| | Silane | | | | | | |
| C-25 | PM-490 | 0.5 | 120 | 8 | 7.5 | 4 | 2 |
| C-26 | PM-490 | 0.5 | 20 | 7 | 6 | — | — |
| C-28 | Untreated | 0 | 0 | 0 | −1 | — | — |
| | Filter | | | | | | |
| | Medium D | | | | | | |

[a] Failed test with 100% water
[b] Not Tested

The complete disclosures of the publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A filter media; wherein the filter media is treated with a composition comprising a silane compound of Formula Ia or Ib: 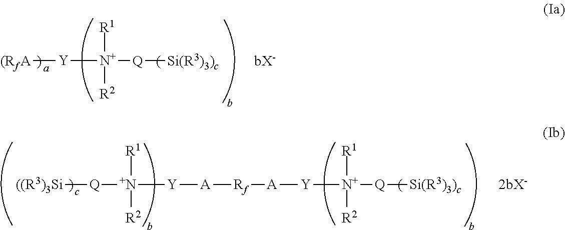
wherein
a, b, and c are independently integers from 1 to 3;
R_{f} is a perfluorinated ether group;
A is a linking group having the formula —C_{d}H_{2d}ZC_{g}H_{2g}—, wherein d and g are independently integers from 0 to 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group;
Y is a bridging group having 1 to 10 carbon atoms, a valency from 2 to 6, and comprising at least one of an alkylene group or an arylene group;
Q is a connecting group having 1 to 10 carbon atoms, a valency from 2 to 6, and comprising at least one of an alkylene group or an arylene group;
R¹ and R² are independently selected from the group consisting of a hydrogen atom, an alkyl group, an aryl group, and an aralkyl group;
each R³ is independently selected from the group consisting of hydroxy groups, alkoxy groups, acyl groups, acyloxy groups, halo groups, and polyether groups; and
X⁻ is a counter ion selected from the group consisting of inorganic anions, organic anions, and combinations thereof.

2. The filter media of claim 1 wherein the filter media is a fibrous filter media.

3. The filter media of claim 2 wherein the media comprises polymeric fibers, glass fibers, ceramic fibers, cellulose fibers, or a combination thereof.

4. The filter media of claim 3 wherein the media comprises polymeric fibers, glass fibers, or a combination thereof.

5. The filter media of any of claim 1 wherein the composition further comprises water.

6. The filter media of any of claim 1 wherein the composition further comprises a water-soluble organic solvent.

7. The filter media of any of claim 1 wherein the perfluorinated ether group is a perfluoropolyether group.

8. The filter media of any of claim 1 wherein the perfluorinated ether group has a weight average molecular weight of at least about 1000.

9. The filter media of any of claim 1 wherein the counter ion X⁻ is selected from the group consisting of a halide, sulfate, phosphate, an alkanoate, an alkyl sulfonate, an aryl sulfonate, an alkyl phosphonate, an aryl phosphonate, a fluorinated alkanoate, a fluorinated alkyl sulfonate, a fluorinated aryl sulfonate, a fluorinated alkyl sulfonimide, a fluorinated alkyl methide, and combinations thereof.

10. The filter media of any of claim 1 wherein at least one of d or g is at least 1, and Z is a covalent bond.

11. The filter media of any of claim 1 wherein the bridging group Y comprises an alkylene group having 1 to 6 carbon atoms.

12. The filter media of any of claim 1 wherein the connecting group Q comprises an alkylene group having 1 to 6 carbon atoms.

13. The filter media of any of claim 1 wherein R¹ and R² are independently a hydrogen atom or an alkyl group having 1 to 8 carbon atoms.

14. The filter media of any of claim 1 wherein the perfluorinated ether group has the structure F(CₘF₂ₘO)ₙCₚF₂ₚ—, wherein m is an integer from 1 to 12, n is an integer from 2 to 10, and p is an integer from 1 to 6.

15. The filter media of any of claim 1 wherein the perfluorinated ether group has the structure F(CF(CF₃)CF₂O)_{q}CF(CF₃)—, wherein q is an integer from 2 to 12.

16. The filter media of any of claim 1 wherein the silane compound is present on the filter media in an amount of about 10% by weight solids or less as determined gravimetrically.

17. The filter media of claim 16 wherein the silane compound is present on the filter media in an amount of about 5% by weight solids or less as determined gravimetrically.

18. The filter media of claim 17 wherein the silane compound is present on the filter media in an amount of about 3% by weight solids or less as determined gravimetrically.

19. A filter media; wherein the filter media is treated with a composition comprising a silane compound of Formula IIa: 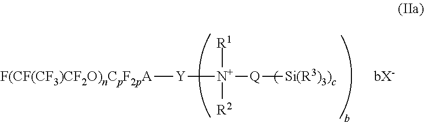
wherein
n is an integer from 2 to 12;
p is an integer from 1 to 6;
b and c are independently integers from 1 to 3;
A is a linking group having the formula —C_{d}H_{2d}ZC_{g}H_{2g}—, wherein d and g are independently integers from 0 to 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group;
Y is a bridging group comprising an alkylene group having 1 to 6 carbon atoms;
Q is a connecting group comprising an alkylene group having 1 to 6 carbon atoms;
R¹ and R² are independently alkyl groups having 1 to 4 carbon atoms;
each R³ is independently selected from the group consisting of hydroxy groups, methoxy groups, ethoxy groups, acetoxy groups, chloro groups, and polyether groups; and
X⁻ is a counterion selected from the group consisting of a halide, sulfate, phosphate, an alkanoate, an alkyl sulfonate, an aryl sulfonate, an alkyl phosphonate, an aryl phosphonate, a fluorinated alkanoate, a fluorinated alkyl sulfonate, a fluorinated aryl sulfonate, a fluorinated alkyl sulfonimide, a fluorinated alkyl methide, and combinations thereof.

20. A filter media; wherein the filter media is treated with a composition comprising a compound of Formula IIb: 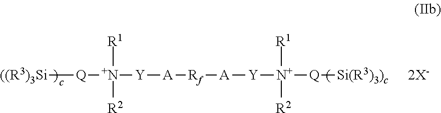
wherein
R_{f} has the structure —CF(CF₃)(OCF₂CF(CF₃))ₘOCF₂CF₂CF₂CF₂O(CF(CF₃)CF₂O)ₙCF(CF₃)—, wherein m is an integer from 1 to 12 and n is an integer from 2 to 10;
b and c are each independently an integer from 1 to 3;
A is a linking group having the formula —C_{d}H_{2d}ZC_{g}H_{2g}—, wherein d and g are independently integers from 0 to 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group;
Y is a bridging group comprising an alkylene group having 1 to 6 carbon atoms;
Q is a connecting group comprises an alkylene group having 1 to 6 carbon atoms;
R¹ and R² are independently alkyl groups having 1 to 4 carbon atoms;
each R³ is independently selected from the group consisting of hydroxy groups, methoxy groups, ethoxy groups, acetoxy groups, chloro groups, and polyether groups; and
X⁻ is a counter ion selected from the group consisting of a halide, sulfate, phosphate, an alkanoate, an alkyl sulfonate, an aryl sulfonate, an alkyl phosphonate, an aryl phosphonate, a fluorinated alkanoate, a fluorinated alkyl sulfonate, a fluorinated aryl sulfonate, a fluorinated alkyl sulfonimide, a fluorinated alkyl methide, and combinations thereof.

21. The filter media of claim 19 wherein the filter media is a fibrous filter media.

22. A method of providing repellency properties to filter media comprising
(a) providing a filter media; and
(b) contacting the filter media with a composition comprising a silane compound of Formula Ia or Ib: 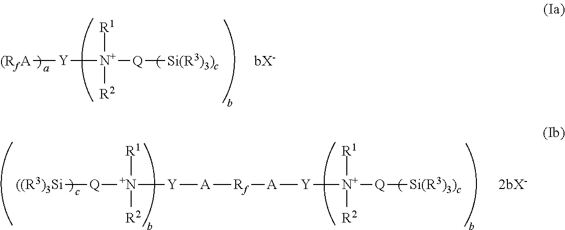
wherein
a, b, and c are independently integers from 1 to 3;
R_{f} is a perfluorinated ether group;
A is a linking group having the formula —C_{d}H_{2d}ZC_{g}H_{2g}—, wherein d and g are independently integers from 0 to 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group;
Y is a bridging group having 1 to 10 carbon atoms, a valency from 2 to 6, and comprising at least one of an alkylene group or an arylene group;
Q is a connecting group having 1 to 10 carbon atoms, a valency from 2 to 6, and comprising at least one of an alkylene group or an arylene group;
R¹ and R² are independently selected from the group consisting of a hydrogen atom, an alkyl group, an aryl group, and an aralkyl group;
each R³ is independently selected from the group consisting of hydroxy groups, alkoxy groups, acyl groups, acyloxy groups, halo groups, and polyether groups; and
X⁻ is a counter ion selected from the group consisting of inorganic anions, organic anions, and combinations thereof.

23. The method of claim 22 wherein the filter media is a fibrous filter media.

24. The method of claim 22 further comprising heat curing the treated filter media.

25. The method of any of claim 22 wherein the silane compound is present in the composition at concentration of about 5% by weight or less.

26. The method of claim 25 wherein the silane compound is present in the composition at concentration of about 1% by weight or less.

27. The method of any of claim 22 wherein the silane compound is present in the composition in a concentration between about 0.05% and about 1% by weight.

28. A method of making a fibrous filter media having repellency properties comprising
(a) providing fibers,
(b) contacting the fibers with a composition comprising a silane compound of Formula Ia or Ib: 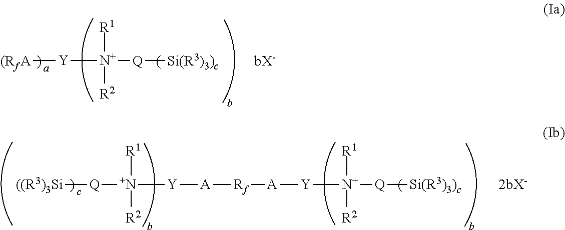
wherein
a, b, and c are independently integers from 1 to 3;
R_{f} is a perfluorinated ether group;
A is a linking group having the formula —C_{d}H_{2d}ZC_{g}H_{2g}—, wherein d and g are independently integers from 0 to 10 and Z is selected from the group consisting of a covalent bond, a carbonyl group, a sulfonyl group, a carboxamido group, a sulfonamido group, an iminocarbonyl group, an iminosulfonyl group, an oxycarbonyl group, a urea group, a urethane group, a carbonate group, and a carbonyloxy group;
Y is a bridging group having 1 to 10 carbon atoms, a valency from 2 to 6, and comprising at least one of an alkylene group or an arylene group;
Q is a connecting group having 1 to 10 carbon atoms, a valency from 2 to 6, and comprising at least one of an alkylene group or an arylene group;
R¹ and R² are independently selected from the group consisting of a hydrogen atom, an alkyl group, an aryl group, and an aralkyl group;
each R³ is independently selected from the group consisting of hydroxy groups, alkoxy groups, acyl groups, acyloxy groups, halo groups, and polyether groups; and
X⁻ is a counter ion selected from the group consisting of inorganic anions, organic anions, and combinations thereof, and
(c) drying the fibers to form a treated fibrous filter media.

29. The filter media of claim 20 wherein the filter media is a fibrous filter media.
